(19) United States
(12) Patent Application Publication
(10) Pub. No.: US 2026/0146169 A1
(43) Pub. Date: May 28, 2026

(54) CATIONIC ELECTRODEPOSITION COATING MATERIAL COMPOSITION

(71) Applicant: Axalta Shinto Coating Systems Co., Ltd., Tokyo (JP)

(72) Inventors: Shoichiro ARAKURA, Hyogo (JP); Takuto NAKANO, Hyogo (JP); Hiroyuki KOMATSU, Hyogo (JP)

(73) Assignee: Axalta Shinto Coating Systems Co., Ltd., Tokyo (JP)

(21) Appl. No.: 18/873,294

(22) PCT Filed: May 22, 2023
(86) PCT No.: PCT/JP2023/018998

§ 371 Date: Aug. 7, 2025

(30) Foreign Application Priority Data
Jun. 28, 2022 (JP) 2022-103270

(51) Int. Cl. C09D 5/44; C09D 163/00; C25D 13/22

(52) U.S. Cl. CPC C09D 5/4473; C09D 5/4438; C09D 163/00; C25D 13/22

(57) ABSTRACT

A cationic electrodeposition coating composition may contain at least two or more different emulsions in a mixed state, in which one of the emulsions is an emulsion (A) of an amine-modified epoxy resin containing a primary amino group or a secondary amino group, and another one of the emulsions is an emulsion (B) of an epoxy compound not containing a primary amino group and a secondary amino group and containing two or more epoxy groups in one molecule. A method for producing said coating composition may include a step of mixing the emulsions (A) and (B). A coating method may be performed in conjunction with the producing method by immersing a metal object in said coating composition and then finishing the coating by drying.

### TECHNICAL FIELD OF THE INVENTION

The present invention relates to a cationic electrodeposition coating composition that does not require, in an electrodeposition coating step, high-temperature baking drying which discharges CO₂, that generates almost no volatile matter during drying of a coating film, and that is extremely excellent in rust prevention property.

### BACKGROUND ART

The cationic electrodeposition coating material is excellent in coating workability and can provide a high-performance rustproof coating film, and thus has been widely used conventionally in automobile parts, industrial products, and the like using metal materials such as iron and aluminum. The reason why a cationic electrodeposition coating film is an excellent rustproof coating film is that an amino group-containing epoxy resin (base) having a high Tg, a blocked isocyanate resin (curing agent) for forming a strong three-dimensional crosslinked coating film, and a curing catalyst are used as main components thereof, and a rustproof metal (rustproof pigment) is further blended. A coated article is baked in a high-temperature drying oven at about 140° C. or higher to complete the rustproof coating film. A gas oven is the mainstream of high-temperature drying ovens. CO₂ generated by gas combustion is regarded as a greenhouse gas, which is problematic, and reduction thereof is desired. In addition, a blocking agent in the curing agent is eliminated and volatilized at the time of baking. Accordingly, a large load is applied for the purification treatment for release to the atmosphere in the factory facility. Such fact can also be taken up as a problem in the environmental aspect.

Examples of the technique that does not require high-temperature baking drying include a method of using a low-temperature-curable blocked isocyanate resin as the curing agent. As for an example of this method, Patent Document 1 discloses a method using a blocked isocyanate curing agent in which an isocyanate is blocked with an oxime compound or a pyrazole compound. However, depending on the type of an isocyanate to be combined, there is the case where it is impossible to achieve both low-temperature curability and long-term stability of a coating material. Accordingly, these blocking agents are practically limited to a combination with an aliphatic isocyanate. Therefore, the baking drying conditions are 110 to 120° C. and remain in relatively high temperature conditions. In addition, most of these blocking agents become volatile components and are released to the outside of the coating film.

Furthermore, as for a technique that does not require high-temperature baking drying, a technique using an oxidative polymerization reaction of a room-temperature curing type can also be mentioned. For example, as in Patent Document 2, an anionic electrodeposition coating material based on a fatty acid-modified acrylic resin is well known. In examples thereof, a coating material is forcibly dried at 80° C. for 30 minutes. However, the reaction rate is very slow, and the degree of crosslinking is not so high.

As for the room-temperature drying type electrodeposition coating material, for example, Patent Document 3 discloses a technique of drying and fixing a component excellent in rust prevention property at room temperature. Since this technique does not utilize a three-dimensional crosslinking type curing mechanism, it is difficult to exhibit rust prevention performance at a level comparable to a current high-temperature baked cured coating film.

In addition, Patent Document 4 discloses a method of spraying a resin solution containing an α,β-unsaturated carbonyl group to a cationic electrodeposition coating film (undried coating film) using a Michael addition reaction for a crosslinking reaction so as to improve the function of the coating film for the purpose of lowering the temperature of the baking conditions and improving the rust prevention property. In this method, a primary amino group or a secondary amino group is contained on the electrodeposition coating film side, and the hardness of the coating film is increased by a crosslinking reaction by a Michael addition reaction with an α,β-unsaturated carbonyl group on the resin solution side so as to improve coating film performance. However, this reaction occurs only on a surface portion where the electrodeposition coating film and the resin solution are in contact with each other. Accordingly, the effect of improving the hardness of the coating film is small. Also, baking drying at a high temperature is required. This is clear from the fact that coating film performance under a baking condition of 150° C. is shown in examples thereof. Accordingly, it has not been possible to actively reduce the temperature.

Similarly, as for a technique using a Michael addition reaction for a crosslinking reaction, Patent Document 5 discloses a technique in which an emulsified amine-modified epoxy resin having a primary amino group or a secondary amino group and an emulsified compound having an α,β-unsaturated carbonyl group are produced separately, and these are mixed to form one electrodeposition coating composition, thereby improving the hardness of the entire coating film as compared with the method of Patent Document 4, and eliminating the need for baking drying at a high temperature. In the technique of Patent Document 5, an amine-modified epoxy resin having a high Tg is used as a main component, and this main component is strongly three-dimensionally crosslinked by a crosslinking reaction by the Michael addition reaction, so that it is considered that a coating film excellent in rust prevention property can be obtained. However, in recent years, in accordance with improvement in performance level in the industry, further improvement in rust prevention property is required.

### PRIOR ART DOCUMENTS

### Patent Documents

Patent Document 1: Japanese Domestic Re-Publication No. WO 2017/138445
Patent Document 2: Japanese Patent Application Laid-Open (JP-A) No. 2003-277679
Patent Document 3: Japanese Patent No. 6398025
Patent Document 4: Japanese Patent Application Laid-Open (JP-A) No. 137777/88
Patent Document 5: Japanese Patent Application Laid-Open (JP-A) No. 2021-138842

### DISCLOSURE OF THE INVENTION

### Problem that the Invention is to Solve

The present invention has been made in view of the above-described current state of the prior art. An object of the present invention is to provide a cationic electrodeposition coating material that does not require, in an electrodeposition coating step, high-temperature baking drying which discharges CO₂, that generates almost no volatile matter during drying of a coating film, and that is extremely excellent in rust prevention property.

### Means for Solving the Problem

As a result of intensive studies to achieve the above object, the present inventors have found that in a cationic electrodeposition coating composition using a Michael addition reaction for a crosslinking reaction as in Patent Document 5, it is also important to control the rate of the Michael addition reaction constituting the crosslinking reaction, and if the rate of the Michael addition reaction constituting the crosslinking reaction is too high, the coating film is cured in a short time, so that the rust prevention property of the resulting coating film may be rather insufficient. Furthermore, the present inventors have found that the rate of the crosslinking reaction can be controlled by changing the type of the counter group to be reacted with the amino group. Then, the present inventors have found that by selecting, as a counter group to be reacted with an amino group, an “epoxy group” instead of the “α,β-unsaturated carbonyl group” as in Patent Document 5, the rate of the crosslinking reaction can be reduced to a suitable range as compared with the case of selecting the “α,β-unsaturated carbonyl group” as in Patent Document 5, whereby the curing time of a coating film can be extended to a suitable range, and consequently the rust prevention property of the resulting coating film can be further improved.

The present invention has been completed on the basis of the above findings and has the following configurations (1) to (10).
(1) A cationic electrodeposition coating composition containing at least two or more different emulsions in a mixed state, in which one of the emulsions is an emulsion (A) of an amine-modified epoxy resin containing a primary amino group or a secondary amino group, and another one of the emulsions is an emulsion (B) of an epoxy compound not containing a primary amino group and a secondary amino group and containing two or more epoxy groups in one molecule.
(2) The cationic electrodeposition coating composition according to (1), wherein the emulsion (A) contains 1.40 to 3.35 milliequivalents of N—H groups of the primary amino group or the secondary amino group per 1 g of a solid content of the emulsion (A), the emulsion (B) contains 1.60 to 9.20 milliequivalents of epoxy groups per 1 g of a solid content of the emulsion (B), and the emulsion (A) and the emulsion (B) are mixed so that reaction sites between these functional groups are in a range of 0.95 to 2.25 milliequivalents per 1 g of a total solid content of the emulsion (A) and the emulsion (B).
(3) The cationic electrodeposition coating composition according to (1), wherein the cationic electrodeposition coating composition further contains a basic catalyst and/or an organometallic compound catalyst as a curing catalyst.
(4) The cationic electrodeposition coating composition according to (1), wherein the cationic electrodeposition coating composition further contains a pigment dispersion paste.
(5) A coating method comprising the steps of: immersing a metal object to be coated in the cationic electrodeposition coating composition according to any one of (1) to (4) to perform electrodeposition coating; and then finishing the coating by low-temperature drying at 80° C. or lower.
(6) A method for producing a cationic electrodeposition coating composition, the method comprising the steps of: providing at least two or more different emulsions; and mixing the emulsions, wherein one of the emulsions is an emulsion (A) of an amine-modified epoxy resin containing a primary amino group or a secondary amino group, and another one of the emulsions is an emulsion (B) of an epoxy compound not containing a primary amino group and a secondary amino group and containing two or more epoxy groups in one molecule.
(7) The method for producing a cationic electrodeposition coating composition according to (6), wherein the emulsion (A) contains 1.40 to 3.35 milliequivalents of N—H groups of the primary amino group or the secondary amino group per 1 g of a solid content of the emulsion (A), the emulsion (B) contains 1.60 to 9.20 milliequivalents of epoxy groups per 1 g of a solid content of the emulsion (B), and the emulsion (A) and the emulsion (B) are mixed so that reaction sites between these functional groups are in a range of 0.95 to 2.25 milliequivalents per 1 g of a total solid content of the emulsion (A) and the emulsion (B).
(8) The method for producing a cationic electrodeposition coating composition according to (6), wherein the method further comprises the step of adding and mixing a basic catalyst and/or an organometallic compound catalyst as a curing catalyst, to the mixed emulsion.
(9) The method for producing a cationic electrodeposition coating composition according to (6), wherein the method further comprises the steps of providing a pigment dispersion paste; and adding and mixing the pigment dispersion paste to the mixed emulsion.
(10) A coating method comprising the steps of: immersing a metal object to be coated in a cationic electrodeposition coating composition produced by the method according to any one of (6) to (9) to perform electrodeposition coating; and then finishing the coating by low-temperature drying at 80° C. or lower.

### Advantages of the Invention

In the cationic electrodeposition coating composition of the present invention, the rate of the crosslinking reaction is controlled within a suitable range by appropriate selection of the type of the reactive group, whereby the curing time of the coating film can be extended to a suitable range. As a result, a coating film extremely excellent in rust prevention property can be obtained. In addition, a coating film having sufficiently high hardness can be obtained without requiring high-temperature baking drying. Accordingly, the combustion amount of the gas in the drying oven can be suppressed, and the CO₂ emission amount can be reduced. In addition, a blocking agent is not used. Accordingly, no byproduct (eliminated component) associated with the curing reaction is generated, and the load on the exhaust treatment facility can also be reduced.

### MODE FOR CARRYING OUT THE INVENTION

A cationic electrodeposition coating composition of the present invention contains, as main constituent components, an emulsion (A) of an amine-modified epoxy resin containing a primary amino group or a secondary amino group and an emulsion (B) of an epoxy compound not containing a primary amino group and a secondary amino group and containing two or more epoxy groups in one molecule, and contains these constituent components in a mixed state. The present invention is essentially characterized in that by selecting an “epoxy group” as a counter group in the emulsion (B) to be reacted with an amino group in the emulsion (A), the rate of the crosslinking reaction is reduced to a suitable range, whereby the curing time of the coating film is extended to a suitable range, and consequently the rust prevention property of the resulting coating film is further improved.

### [Emulsion (A) of an Amine-Modified Epoxy Resin Containing a Primary Amino Group or a Secondary Amino Group]

Among the components constituting the amine-modified epoxy resin, an epoxy skeleton is a polycondensate of a glycidyl ether of a polyphenol having two epoxy groups per molecule on average and two phenolic hydroxy groups in one molecule. Preferable polyphenols include resorcinol, hydroquinone, 2,2-bis-(4-hydroxyphenyl)-propane, 4,4′-dihydroxybenzophenone, 1,1-bis-(4-hydroxyphenyl)-methane, 1,1-bis-(4-hydroxyphenyl)-ethane, 4,4′-dihydroxybiphenyl, and the like. Among them, 2,2-bis-(4-hydroxyphenyl)-propane, what is called bisphenol A, is particularly preferable. A glycidyl ether of a diol having two alcoholic hydroxy groups in one molecule can also be used in combination with the glycidyl ether of the above-mentioned polyphenol. Preferable diols include low molecular weight diols such as ethylene glycol, propylene glycol, 1,4-butanediol, 1,6-hexanediol, neopentyl glycol, diethylene glycol, triethylene glycol, and 1,4-cyclohexanediol; and oligomeric diols such as polyethylene glycol, polypropylene glycol, and polytetramethylene glycol, but are not limited thereto.

Since the epoxy terminal in the epoxy skeleton is basically aminated, in order to make the epoxy resin contain a primary amino group, it is conceivable to obtain a ketimine compound by reacting ethylaminoethylamine, N-(aminoethyl)ethanolamine, diethylenetriamine, or the like having one secondary amino group and one or more primary amino groups in one molecule with a ketone compound such as methyl ethyl ketone and methyl isobutyl ketone, and to add the secondary amino group contained in the ketimine compound to the epoxy group. The moiety turned into a ketimine is easily hydrolyzed by water used when the resin is emulsified to regenerate a primary amino group, whereby an amine-modified epoxy resin containing a primary amino group is completed. In addition, in order to make the epoxy resin contain a secondary amino group, it is conceivable to react one of two active hydrogens of the primary amino group with, for example, monoepoxy, monoisocyanate, or the like to convert the primary amino group into a secondary amino group. According to this method, the ratio between the primary amino groups and the secondary amino groups in the epoxy resin can be changed variously.

When it is desired to reduce the concentrations of primary amino groups and secondary amino groups in the epoxy resin, one possible method is to reduce the blending amount of the ketimine compound. However, if a large amount of epoxy groups are left, primary amino groups regenerated due to a slight amount of moisture in the resin may react with the epoxy groups, and the stability of the resin may be impaired. In order to prevent this, if necessary, for example, an amine compound having one active hydrogen in one molecule, a compound having one carboxy group in one molecule, a compound having one phenolic hydroxy group in one molecule, or the like can be added to a part of the epoxy groups to end-cap the epoxy groups. A few examples of general-purpose compounds include N-methylethanolamine and diethanolamine as for an amine compound having one active hydrogen in one molecule; acrylic acid and linoleic acid as for a compound having one carboxy group in one molecule; and 4-tert-butylphenol and 4-octylphenol as for a compound having one phenolic hydroxy group in one molecule, but are not limited thereto.

The number average molecular weight of such an amine-modified epoxy resin is preferably 1500 to 3500. When the number average molecular weight is less than the above lower limit, the resin may be softened, so that the rust prevention property of the coating film may be deteriorated. When the number average molecular weight exceeds the above upper limit, the resin may be hardened, so that the coating surface may not be finished smoothly.

The emulsion (A) of the amine-modified epoxy resin can be produced by adding a neutralizing acid to the amine-modified epoxy resin to emulsify the resin. Examples of the neutralizing acid include acetic acid, lactic acid, formic acid, propionic acid, methanesulfonic acid, and sulfamic acid. Furthermore, if necessary, a known solvent or plasticizer may be added to emulsify the resin.

The concentration of N—H groups of the primary amino groups or the secondary amino groups in the emulsion (A) is preferably 1.40 to 3.35 milliequivalents, and more preferably 1.45 to 3.30 milliequivalents, per 1 g of the solid content of the emulsion (A). When the concentration of the N—H groups of the primary amino groups or the secondary amino groups in the emulsion (A) is less than the above lower limit, the curability of the coating film may be insufficient, and the rust prevention property of the coating film may be deteriorated. When the concentration exceeds the above upper limit, the conductivity of the emulsion may become too strong, and it may become difficult to control the electrodeposition property, so that the uniformity of the coating film may be deteriorated.

### [Emulsion (B) of an Epoxy Compound not Containing a Primary Amino Group and a Secondary Amino Group and Containing Two or More Epoxy Groups in One Molecule]

The epoxy compound that does not contain a primary amino group and a secondary amino group and contains two or more epoxy groups in one molecule is not particularly limited, but for example, a compound having a benzene ring structure in the main chain, such as a bisphenol A type epoxy resin, is preferable for sufficiently securing reactivity with an amine. A compound having a polyfunctional epoxy group and having a low molecular weight is further preferable. When such a compound is used, the concentration of functional groups can be adjusted to a high concentration, whereby the number of crosslinking reaction sites increases, so that the coating film is further strengthened, and a good rust prevention property is easily secured.

Specifically, as for the epoxy compound that does not contain a primary amino group and a secondary amino group and contains two or more epoxy groups in one molecule, for example, an epoxy compound obtained by a reaction of a polyphenol compound with epichlorohydrin can be used. Examples of the polyphenol compound include bis(4-hydroxyphenyl)-2,2-propane [bisphenol A], bis(4-hydroxyphenyl)methane [bisphenol F], bis(4-hydroxycyclohexyl)methane [hydrogenated bisphenol F], 2,2-bis(4-hydroxycyclohexyl)propane [hydrogenated bisphenol A], 4,4′-dihydroxybenzophenone, bis(4-hydroxyphenyl)-1,1-ethane, bis(4-hydroxyphenyl)-1,1-isobutane, bis(4-hydroxy-3-tert-butyl-phenyl)-2,2-propane, bis(2-hydroxynaphthyl) methane, tetra(4-hydroxyphenyl)-1,1,2,2-ethane, and 4,4′-dihydroxydiphenyl sulfone.

Examples also include glycidyl ether type epoxy compounds such as ethylene glycol diglycidyl ether, diethylene glycol diglycidyl ether, polyethylene glycol diglycidyl ether, 1,2-propylene glycol diglycidyl ether, polypropylene glycol diglycidyl ether, 1,4-butanediol diglycidyl ether, diglycidyl ether, and neopentyl glycol diglycidyl ether. Since there is the possibility that the reactivity with an amine is reduced as compared with the epoxy compound obtained by the reaction of the polyphenol compound with epichlorohydrin, it is preferable to use the glycidyl ether type epoxy compound in combination with the epoxy compound obtained by the reaction of the polyphenol compound with epichlorohydrin.

Examples of the epoxy compound containing more than two epoxy groups on average include compounds such as 4,4′-methylenebis(N,N-diglycidylaniline)4-(2,3-epoxypropan-1-yloxy)-N,N-bis(2,3-epoxypropan-1-yl)-2-methylaniline, 1,3-bis(oxiranylmethoxy)-2-propanol, tetraglycidyldiaminodiphenylmethane, tetraglycidyldiaminodiphenylsulfone, tetraglycidylxylylenediamine, triglycidylaminophenol, triglycidylaminocresol, phenol novolac-type epoxy, and cresol novolac-type epoxy.

As for a representative example of the material of the epoxy compound, those described above have been exemplified, but the material is not limited thereto, and two or more types thereof can be used in a mixed state.

The epoxy compound that does not contain a primary amino group and a secondary amino group and contains two or more epoxy groups in one molecule does not have an amino group unlike the amine-modified epoxy resin containing a primary amino group or a secondary amino group of the emulsion (A), and thus cannot be emulsified only by adding a neutralizing acid. Therefore, an auxiliary component for emulsification is required. An example of the auxiliary component is a tertiary amine type epoxy resin having a tertiary amino group as an epoxy terminal. By blending the resin with the epoxy compound that does not contain a primary amino group and a secondary amino group and contains two or more epoxy groups in one molecule, and adding a neutralizing acid, the epoxy compound that does not contain a primary amino group and a secondary amino group and contains two or more epoxy groups in one molecule can be emulsified. An epoxy skeleton of a tertiary amine type epoxy resin is a polycondensate of a glycidyl ether of a polyphenol having two epoxy groups per molecule on average and two phenolic hydroxy groups in one molecule, and an epoxy resin using bisphenol A is suitable. The epoxy terminal is preferably derived from an alkanolamine having a hydroxy group such as N-methylethanolamine and diethanolamine, from the viewpoint of emulsifiability and the rust prevention property. In the process of producing the tertiary amine type epoxy resin, these amines react with the epoxy groups to become tertiary amines, and active hydrogens disappear. Accordingly, the obtained tertiary amine type epoxy resins do not have reactivity with the epoxy group. Therefore, even when such a tertiary amine type epoxy resin is blended with an epoxy compound that does not contain a primary amino group and a secondary amino group and contains two or more epoxy groups in one molecule, the tertiary amine type epoxy resin does not react with the epoxy groups in the epoxy compound, and the obtained emulsion is stable. Similar to the emulsion (A), examples of the neutralizing acid include acetic acid, lactic acid, formic acid, propionic acid, methanesulfonic acid, and sulfamic acid. Furthermore, if necessary, a known solvent or plasticizer may be added to emulsify the resin.

An emulsion may be produced using an emulsifier instead of the tertiary amine type epoxy resin. Examples of the emulsifier include cationic emulsifiers and nonionic emulsifiers. Two or more of these may be mixed and used. In the case of a compound having a plurality of epoxy groups in one molecule, an emulsion having the same function can be produced by reacting a part of the compound with an amine to adjust the number of remaining epoxy groups to two or more per molecule.

The concentration of epoxy groups in the emulsion (B) is preferably 1.60 to 9.20 milliequivalents per 1 g of the solid content of the emulsion (B). The lower limit of the concentration of epoxy groups in the emulsion (B) is more preferably 1.90 milliequivalents, further preferably 2.50 milliequivalents, and particularly preferably 3.00 milliequivalents. On the other hand, the upper limit of the concentration of epoxy groups in the emulsion (B) is more preferably 9.15 milliequivalents, further preferably 9.00 milliequivalents, and particularly preferably 8.80 milliequivalents. When the concentration of epoxy groups in the emulsion (B) is less than the above lower limit, the curability of the coating film may be insufficient, and the rust prevention property of the coating film may be deteriorated. On the other hand, the case where the concentration of epoxy groups in the emulsion (B) exceeds the above upper limit is limited to the case where the blending ratio of the epoxy group-containing compound (insoluble component) in the emulsion (B) is increased and the blending ratio of the tertiary amine type epoxy resin blended as an auxiliary component for emulsification is reduced, but this may make it difficult to secure the stability of the emulsion (B).

### [Curing Catalyst]

In order to promote the addition reaction between the amine in the emulsion (A) of the amine-modified epoxy resin and the epoxy in the emulsion (B) of the epoxy compound, the cationic electrodeposition coating composition of the present invention preferably further contains a basic catalyst and/or an organometallic compound catalyst as a curing catalyst. Specific examples of the basic catalyst include alkali metal hydroxides, alkali metal carbonates, quaternary ammonium compounds, tertiary amine compounds, guanidine compounds, amidine compounds, tertiary phosphine compounds, phosphazene compounds, tertiary sulfonium compounds, quaternary phosphonium compounds, and imidazole compounds. Examples of the organometallic compound catalyst include cobalt octylate, manganese octylate, zinc octylate, zirconium octylate, acetylacetone complexes of cobalt, acetylacetone complexes of zinc, and acetylacetone complexes of zirconium. The type of the curing catalyst is not particularly limited, and one type can be used singly, or two or more types can be used in combination. Organotin compounds such as dibutyltin dilaurate and dioctyltin oxide can also be used in terms of catalytic function, but toxicity thereof has been regarded as a problem in recent years, and use regulation has been considered. Accordingly, it is preferable that the organotin compounds are not used in the cationic electrodeposition coating composition of the present invention.

### [Cationic Electrodeposition Coating Composition]

The cationic electrodeposition coating composition of the present invention is produced by separately providing the emulsion (A) and the emulsion (B) and mixing these emulsions. With regard to the blending ratio of the emulsion (A) and the emulsion (B) constituting the cationic electrodeposition coating composition of the present invention, it is preferable that the reaction sites between primary amino groups or secondary amino groups provided by the emulsion (A) and epoxy groups provided by the emulsion (B) are in the range of 0.95 to 2.25 milliequivalents, and preferably in the range of 1.00 to 2.20 milliequivalents, per 1 g of the total solid content of the emulsion (A) and the emulsion (B). When the amount of the reaction sites is less than the above lower limit, there is a possibility that sufficient curability may not be exhibited due to lack of reaction sites, and thus the rust prevention property may be deteriorated. When the amount of the reaction sites exceeds the above upper limit, there is a possibility that there may be excessive reaction sites, whereby the curing rate may excessively be increased, and thus coating film flowability may be deteriorated.

### [Pigment Dispersion Paste]

In addition to the emulsion (A), the emulsion (B), and the curing catalyst, a dispersion paste of a pigment such as an extender pigment and a rust preventive pigment can be added to the cationic electrodeposition coating composition of the present invention as necessary. The resin for dispersing the pigment may be a known resin, and a tertiary amine type resin obtained by neutralizing an amine-modified epoxy resin with formic acid, acetic acid, lactic acid, sulfamic acid, methanesulfonic acid, or the like, or a quaternary ammonium salt type resin obtained by quaternizing an epoxy terminal can be used. Kaolin, talc, aluminum silicate, calcium carbonate, mica, clay, silica, or the like can be used as the extender pigment. Carbon black, titanium white, red iron oxide, or the like can be used as the color pigment. Zinc phosphate, iron phosphate, aluminum phosphate, calcium phosphate, aluminum tripolyphosphate, zinc molybdate, aluminum molybdate, calcium molybdate, a bismuth compound, or the like can be used as the rust preventive pigment. Surfactants such as an antifoaming agent and a surface tension modifier can also be used without particular limitation as long as they are known. In the case where the pigment dispersion paste is added, the solid content thereof is preferably in the range of 15 to 55 parts by mass per 100 parts by mass of the total solid content described above. It is also possible to add a solvent. However, when a large amount of solvent is used, the solvent may not escape from the coating film, and there is a possibility that curability of the coating film is impaired. This is because the cationic electrodeposition coating composition of the present invention is mainly dried at a low temperature. The use of a large amount of solvent is not preferable also from an environmental aspect because a large amount of solvent is discharged into the atmosphere.

In order to perform coating using the cationic electrodeposition coating composition of the present invention, electrodeposition coating may be performed by immersing a metal object to be coated in the cationic electrodeposition coating composition produced as described above. The metal object to be coated can be, for example, an automobile component or an industrial product using a metal material such as iron and aluminum. The conditions for the electrodeposition coating are not particularly limited, and the electrodeposition coating may be performed in accordance with a conventional method. The coating film formed from the cationic electrodeposition coating composition of the present invention has sufficiently high hardness. Accordingly, it is not necessary to perform baking drying at a high temperature of 140° C. or higher for further curing as in a conventional method, and drying at a low temperature of about 80° C. or lower for removing moisture is sufficient.

### EXAMPLES

As hereunder, the present invention will be more specifically illustrated by referring to Examples. However, the present invention is not limited by the following Examples. In the examples, “part” means part by mass, and “%” means mass %.

### Preparation of Raw Materials

### Production of an Amine-Modified Epoxy Resin (R-1) Containing a Primary Amino Group or a Secondary Amino Group

A flask equipped with a stirrer, a thermometer, and a reflux condenser was charged with 277 parts of bisphenol A diglycidyl ether having an epoxy equivalent of 187, 512 parts of polypropylene glycol diglycidyl ether having an epoxy equivalent of 300, 257 parts of bisphenol A, 55 parts of methyl isobutyl ketone, and 0.4 parts of tributylamine, and temperature rising was started under stirring. The mixture was kept at 150° C. for 7 hours and then cooled to 90° C. while 295 parts of methyl isobutyl ketone was added. Subsequently, 203 parts of a ketimine compound (70% concentration) synthesized in advance from ethylaminoethylamine and methyl isobutyl ketone was added. The temperature was kept at 100° C. for 5 hours, and then the mixture was cooled to 70° C. to provide an amine-modified epoxy resin (R-1) containing a primary amino group or a secondary amino group and having a solid content of 70%. The number average molecular weight of this resin was 2406. The content of the primary amino group or the secondary amino group (N—H group) in this resin was 1.50 milliequivalents per 1 g of the solid content.

### Production of an Amine-Modified Epoxy Resin (R-2) Containing a Primary Amino Group or a Secondary Amino Group

A flask equipped with a stirrer, a thermometer, and a reflux condenser was charged with 275 parts of bisphenol A diglycidyl ether having an epoxy equivalent of 187, 509 parts of polypropylene glycol diglycidyl ether having an epoxy equivalent of 300, 256 parts of bisphenol A, 54 parts of methyl isobutyl ketone, and 0.4 parts of tributylamine, and temperature rising was started under stirring. The mixture was kept at 150° C. for 7 hours and then cooled to 90° C. while 236 parts of methyl isobutyl ketone was added. Subsequently, 107 parts of a ketimine compound (70% concentration) synthesized in advance from ethylaminoethylamine and methyl isobutyl ketone was added. Then, 167 parts of a ketimine compound (70% concentration) synthesized in advance from diethylenetriamine and methyl isobutyl ketone was added. The temperature was kept at 100° C. for 5 hours, and then the mixture was cooled to 70° C. to provide an amine-modified epoxy resin (R-2) containing a primary amino group or a secondary amino group and having a solid content of 70%. The number average molecular weight of this resin was 2422. The content of the primary amino group or the secondary amino group (N—H group) in this resin was 2.35 milliequivalents per 1 g of the solid content.

### Production of an Amine-Modified Epoxy Resin (R-3) Containing a Primary Amino Group or a Secondary Amino Group

A flask equipped with a stirrer, a thermometer, and a reflux condenser was charged with 274 parts of bisphenol A diglycidyl ether having an epoxy equivalent of 187, 507 parts of polypropylene glycol diglycidyl ether having an epoxy equivalent of 300, 255 parts of bisphenol A, 54 parts of methyl isobutyl ketone, and 0.4 parts of tributylamine, and temperature rising was started under stirring. The mixture was kept at 150° C. for 7 hours and then cooled to 90° C. while 173 parts of methyl isobutyl ketone was added. Subsequently, 351 parts of a ketimine compound (70% concentration) synthesized in advance from diethylenetriamine and methyl isobutyl ketone was added. The temperature was kept at 100° C. for 5 hours, and then the mixture was cooled to 70° C. to provide an amine-modified epoxy resin (R-3) containing a primary amino group or a secondary amino group and having a solid content of 70%. The number average molecular weight of this resin was 2436. The content of the primary amino group or the secondary amino group (N—H group) in this resin was 3.26 milliequivalents per 1 g of the solid content.

### Production of an Emulsion (A)

### Production of Emulsions E1 to E3

Three types of emulsions, E1 to E3, were produced as the emulsion (A) according to the raw material formulation listed in Table 1. A specific procedure is as follows.

In stainless steel beakers each equipped with a stirrer and a thermometer, predetermined amount of the amine-modified epoxy resin (R-1), (R-2), or (R-3) produced as the amine-modified epoxy resin containing a primary amino group or a secondary amino group as described above was respectively placed, and temperature rising was started under stirring. Subsequently, a 70% aqueous solution of methanesulfonic acid was added as a neutralizing acid, and the mixture was kept at 70° C. for 1 hour, then heating was stopped, and deionized water was slowly added to emulsify the mixture. The container was not covered, stirring was continued at normal temperature for 48 hours, and the volatilized content was supplemented with deionized water to provide each of emulsions E1 to E3 having a solid content of 15.0%.

TABLE 1

| emulsion (A) | | E1 | E2 | E3 |
|---|---|---|---|---|
| amine-modified epoxy resin of | resin name | R-1 | R-2 | R-3 |
| Production Examples 1 to 3 | blending amount | 857 | 857 | 857 |
| 70% aqueous solution of | blending amount | 82 | 82 | 82 |
| methanesulfonic acid | | | | |
| deionized water | blending amount | 3061 | 3061 | 3061 |
| total | blending amount | 4000 | 4000 | 4000 |

*Numbers in the table represent mass [g].

### Production of an Emulsion (B)

### Production of Emulsions E4 to E6

Three types of emulsions, E4 to E6, were produced as the emulsion (B) according to the raw material formulation listed in Table 2. A specific procedure is as follows.

In stainless steel beakers each equipped with a stirrer and a thermometer, predetermined amount of (i) bisphenol A diglycidyl ether (the content of the epoxy group was 5.35 milliequivalents per 1 g of the solid content), (ii) 4-(2,3-epoxypropan-1-yloxy)-N,N-bis(2,3-epoxypropan-1-yl)-2-methylaniline (the content of the epoxy group was 10.31 milliequivalents per 1 g of the solid content), or (iii) a novolak-modified epoxy resin (the content of the epoxy group was 5.49 milliequivalents per 1 g of the solid content) was respectively charged as the epoxy compound that did not contain a primary amino group and a secondary amino group and contained two or more epoxy groups in one molecule. Then, a tertiary amine type epoxy resin (T-1) produced as follows was further added as an auxiliary component for emulsification, and temperature rising was started under stirring. Subsequently, a 70% aqueous solution of methanesulfonic acid was added as a neutralizing acid, and the mixture was kept at 70° C. for 1 hour, then heating was stopped, and deionized water was slowly added to emulsify the mixture. The container was not covered, stirring was continued at normal temperature for 48 hours, and the volatilized content was supplemented with deionized water to provide each of emulsions E4 to E6 having a solid content of 15.0%.

### Production of a Tertiary Amine Type Epoxy Resin (T-1) (an Auxiliary Component for Emulsification)

A flask equipped with a stirrer, a thermometer, and a reflux condenser was charged with 493 parts of bisphenol A diglycidyl ether having an epoxy equivalent of 187, 267 parts of polypropylene glycol diglycidyl ether having an epoxy equivalent of 300, 265 parts of bisphenol A, 71 parts of methyl isobutyl ketone, and 0.3 parts of tributylamine, and temperature rising was started under stirring. The mixture was kept at 150° C. for 3 hours and then cooled to 90° C. while 241 parts of methyl isobutyl ketone was added. Subsequently, 120 parts of diethanolaminewas added. Then, the temperature was kept at 100° C. for 2 hours, and then the mixture was cooled to 70° C. to provide a tertiary amine type epoxy resin (T-1) having a solid content of 70%.

### Production of an Emulsion E7

An emulsion E7 is an example in which the need for the use of an auxiliary component for emulsification was eliminated by the use of a tertiary amine type epoxy resin (S-1) based on the novolak-modified epoxy resin (iv) as the epoxy compound that did not contain a primary amino group and a secondary amino group and contained two or more epoxy groups in one molecule.

A flask equipped with a stirrer, a thermometer, and a reflux condenser was charged with 519 parts of a novolak-modified epoxy resin (the content of the epoxy group was 5.49 milliequivalents per 1 g of the solid content) and 257 parts of methyl isobutyl ketone, and temperature rising was started under stirring. At 90° C., 81 parts of diethanolamine was added, and the mixture was kept at 100° C. for 2 hours and then cooled to 60° C. to provide the tertiary amine type epoxy resin (S-1) having the solid content of 70% in which an amine was added to a part thereof. Subsequently, a 70% aqueous solution of methanesulfonic acid was added as a neutralizing acid, and the mixture was kept at 70° C. for 1 hour, then heating was stopped, and deionized water was slowly added to emulsify the mixture. The container was not covered, stirring was continued at normal temperature for 48 hours, and the volatilized content was supplemented with deionized water to provide emulsion E7 having a solid content of 15.0%.

TABLE 2

| emulsion (B) | | E4 | E5 | E6 | E7 |
|---|---|---|---|---|---|
| epoxy compound not containing | type | (i) | (ii) | (iii) | (iv) |
| a primary amino group and a | blending | 480 | 480 | 480 | 857 |
| secondary amino group and | amount | | | | |
| containing two or more epoxy | | | | | |
| groups in one molecule | | | | | |
| tertiary amine type epoxy | blending | 171 | 171 | 171 | |
| resin (T-1) (an auxiliary | amount | | | | |
| component for emulsification) | | | | | |
| 70% aqueous solution of | blending | 13 | 13 | 13 | 63 |
| methanesulfonic acid | amount | | | | |
| deionized water | blending | 3336 | 3336 | 3336 | 3080 |
| | amount | | | | |
| total | blending | 4000 | 4000 | 4000 | 4000 |
| | amount | | | | |

*Numbers in the table represent mass [g].

Production of an Integrated Emulsion E8 (as a Comparative Example)

As a comparative example, the two components, which were an amine-modified epoxy resin containing a highly reactive primary amino group or secondary amino group and a compound not containing a primary amino group and a secondary amino group and containing two or more epoxy groups in one molecule, were mixed from the beginning so as to be present in the same emulsion to produce an integrated emulsion (emulsion E8). This is contrary to the separate production of these two components as the emulsion (A) and the emulsion (B). A specific procedure is as follows.

A stainless steel beaker equipped with a stirrer and a thermometer was charged with predetermined amounts of raw materials listed in Table 3, and stirring was started. Subsequently, a 70% aqueous solution of methanesulfonic acid was added as a neutralizing acid, and the mixture was kept at 30° C. for 1 hour, and deionized water was slowly added to emulsify the mixture. The container was not covered, stirring was continued at normal temperature for 48 hours, and the volatilized content was supplemented with deionized water to provide emulsion E8 having a solid content of 15.0%.

### Production of a Compound Containing Two or More α,β-Unsaturated Carbonyl Groups in One Molecule, and Production of an Emulsion E9 Using it (as a Comparative Example)

As a comparative example, a compound containing two or more α,β-unsaturated carbonyl groups in one molecule instead of the epoxy groups in the compound contained in the emulsion (B) was produced. Then, and an emulsion E9 was produced using this compound.

A flask equipped with a stirrer, a thermometer, and a reflux condenser was charged with 602 parts of polymeric MDI (trade name: SUMIDUR 44V-20L) and 480 parts of methyl isobutyl ketone, and temperature rising was started under stirring. While the temperature was kept at 60 to 80° C., 518 parts of 2-hydroxyethyl acrylate was added dropwise, and after completion of the addition, the mixture was kept at 85° C. for 5 hours to provide a compound containing α,β-unsaturated carbonyl groups having a solid content of 70%. The content of the α,β-unsaturated carbonyl groups in this compound was 3.98 milliequivalents per 1 g of the solid content.

Further, 686 parts of the compound containing α,β-unsaturated carbonyl groups was charged in a stainless steel beaker equipped with a stirrer and a thermometer, 171 parts of the compound of Production Example 4 (T-1) was further added as an auxiliary component for emulsification, and temperature rising was started under stirring. Subsequently, 13 parts of a 70% aqueous solution of methanesulfonic acid was added as a neutralizing acid, and the mixture was kept at 70° C. for 1 hour, then heating was stopped, and deionized water was slowly added to emulsify the mixture. The container was not covered, stirring was continued at normal temperature for 48 hours, and the volatilized content was supplemented with deionized water to provide emulsion E9 having a solid content of 15.0%.

TABLE 3

| emulsion (B) | | E8 | E9 |
|---|---|---|---|
| amine-modified epoxy resin (R-1) | blending amount | 600 | |
| epoxy compound (i) | blending amount | 144 | |
| compound containing α, β - | blending amount | | 686 |
| unsaturated carbonyl groups | | | |
| tertiary amine type epoxy resin | blending amount | 51 | 171 |
| (T-1) (an auxiliary component | | | |
| for emulsification) | | | |
| 70% aqueous solution of | blending amount | 63 | 13 |
| methanesulfonic acid | | | |
| deionized water | blending amount | 3142 | 3130 |
| total | blending amount | 4000 | 4000 |

*Numbers in the table represent mass [g].

### Production of a Pigment Dispersion Paste

A flask equipped with a stirrer, a thermometer, and a reflux condenser was charged with 518 parts of bisphenol A diglycidyl ether having an epoxy equivalent of 187, 45 parts of polypropylene glycol diglycidyl ether having an epoxy equivalent of 300, 221 parts of bisphenol A, and 1.6 parts of dimethylbenzylamine, and temperature rising was started under stirring. The mixture was kept at 150° C. for 4 hours and then cooled to 70° C. while 550 parts of Butyl CELLOSOLVE was added. Subsequently, 87 parts of dimethylethanolamine and 177 parts of a 50% aqueous lactic acid solution were added, and the mixture was kept at 80° C. for 2 hours to provide a quaternary ammonium salt type pigment dispersion resin having a solid content of 60%.

A container was charged with 1952 parts of deionized water, then 1193 parts of the pigment dispersion resin, 711 parts of kaolin, 928 parts of titanium oxide, 36 parts of carbon black, and 108 parts of bismuth oxide were sequentially charged under stirring, the mixture was uniformly mixed at room temperature for 1 hour, and the mixture was dispersed with a bead mill until the dispersion particle size reached 15 μm or less to provide a pigment dispersion paste having a solid content of 53%.

### Examples 1 to 10 and Comparative Examples 1 to 3

Cationic electrodeposition coating compositions of Examples 1 to 10 and Comparative Examples 1 to 3 were produced according to the formulations shown in Tables 4 to 6. A specific procedure is as follows.

Predetermined amounts of corresponding ones of the emulsions E1 to E9 produced as described above were weighed in a container and uniformly mixed. The pigment dispersion paste produced as described above was further added in Example 10. Thus, a total of 13 kinds of cationic electrodeposition coating compositions were obtained.

Using the obtained cationic electrodeposition coating composition, a metal object to be coated was coated by the following procedure to produce a test plate. Using this test plate, the coating surface smoothness, curability, and rust prevention property were evaluated by the following procedure. In addition, bath liquid stability was evaluated by the following procedure using the obtained cationic electrodeposition coating composition. These results are shown in Tables 4 to 6 together with the formulations and characteristics of the coating compositions.

### <Production of a Test Plate>

A cold-rolled steel sheet (70×150×0.8 mm in size) subjected to a zinc phosphate conversion treatment was immersed as an object to be coated in a bath of the cationic electrodeposition coating composition adjusted to a liquid temperature of 28° C. Then, and coating was performed with the voltage adjusted so that the coating film thickness was 15 μm. After the coating, the product was washed with water, subjected to draining and drying at 80° C. for 20 minutes, and used for the test.

### <Coating Surface Smoothness>

Using Surftest (SJ-301) manufactured by Mitutoyo Corporation, the Ra value of the test plate was measured with a cutoff of 2.5 and evaluated according to the following criteria. For the evaluation, A to C were regarded as acceptable, and D was regarded as unacceptable.
A: The Ra value is 0.30 μm or less.
B: The Ra value is more than 0.30 μm and 0.40 μm or less.
C: The Ra value is more than 0.40 μm, but the product is uniform and does not have uncoated portion (noticeable defect portion).
D: The Ra value is more than 0.40 μm, and the product is not uniform and has uncoated portion (noticeable defect portion).

### <Curability (Rubbing Property)>

Absorbent cotton impregnated with MIBK was reciprocated on the test plate 10 times with a load of 1 kg. Then, and the states of the absorbent cotton and the coating film were evaluated according to the following criteria. For the evaluation, A to C were regarded as acceptable, and D was regarded as unacceptable.
A: The coating film is not dissolved at all.
B: The coating film is slightly dissolved, and a small amount of scratches are formed.
C: The coating film is dissolved, and a decrease in gloss at the rubbed portion is observed.
D: The coating film is almost dissolved.

### <Rust Prevention Property>

A cross-cut reaching the basic material of the test plate was made using a box cutter, and the test was performed for 840 hours with a salt spray tester (SST, 5% salt water, kept at 35° C.). Then, the corrosion width (rust width and swell width) from the cross-cut part was measured and evaluated according to the following criteria. For the evaluation, A to C were regarded as acceptable, and D was regarded as unacceptable.
A: The maximum corrosion width is 3 mm or less from the cut part on one side.
B: The maximum corrosion width is more than 3 mm and 4 mm or less from the cut part on one side.
C: The maximum corrosion width is more than 4 mm and 5 mm or less from the cut part on one side.
D: The maximum corrosion width is more than 5 mm from the cut part on one side.

### <Bath Liquid Stability>

The cationic electrodeposition coating composition sealed in a container was continuously stirred at 30° C. for 30 days and filtered with a 325-mesh wire mesh. Then, and the mass of the residue (aggregate) was measured and evaluated according to the following criteria. For the evaluation, A to C were regarded as acceptable, and D was regarded as unacceptable.
A: The mass of the residue is 1.0 mg/L or less.
B: The mass of the residue is more than 1.0 mg/L and 2.0 mg/L or less.
C: The mass of the residue is more than 2.0 mg/L and 3.0 mg/L or less.
D: The mass of the residue is more than 3.0 mg/L, and the aggregate also adheres to the container and the stirring blade.

TABLE 4

| | | Example | | Example | | Example | | Example | | Example | |
|---|---|---|---|---|---|---|---|---|---|---|---|
| | | 1 | | 2 | | 3 | | 4 | | 5 | |
| type of | No. of emulsion (A) | E1 | | E1 | | E1 | | E2 | | E2 | |
| emulsion | No. of emulsion (B) | E4 | | E4 | | E5 | | E4 | | E5 | |
| | integrated emulsion | — | | — | | — | | — | | — | |
| blending | emulsion (A) [parts] | 2680 | | 2960 | | 3400 | | 2600 | | 3120 | |
| | emulsion (B) [parts] | 1320 | | 1040 | | 600 | | 1400 | | 880 | |
| | integrated emulsion [parts] | 0 | | 0 | | 0 | | 0 | | 0 | |
| | pigment dispersion paste [parts] | 0 | | 0 | | 0 | | 0 | | 0 | |
| | total [parts] | 4000 | | 4000 | | 4000 | | 4000 | | 4000 | |
| characteristic | solid content ratio of (A) | 67 | | 74 | | 85 | | 65 | | 78 | |
| | solid content ratio of (B) | 33 | | 26 | | 15 | | 35 | | 22 | |
| | N—H group concentration in (A) | 1.50 | | 1.50 | | 1.50 | | 2.35 | | 2.35 | |
| | epoxy group concentration in (B) | 4.28 | | 4.28 | | 8.25 | | 4.28 | | 8.25 | |
| | N—H group concentration in (A + B) | 1.00 | | 1.11 | | 1.27 | | 1.52 | | 1.83 | |
| | epoxy group concentration in (A + B) | 1.41 | | 1.11 | | 1.24 | | 1.50 | | 1.81 | |
| | reaction sites between the N—H | 1.00 | | 1.11 | | 1.24 | | 1.50 | | 1.81 | |
| | groups and the epoxy groups | | | | | | | | | | |
| evaluation | coating surface smoothness (Ra) | A | (0.22) | B | (0.32) | B | (0.37) | C | (0.43) | C | (0.50) |
| | curability (rubbing property) | C | | C | | B | | B | | A | |
| | rust prevention property (SST) | C | (4.1) | C | (4.4) | B | (3.5) | B | (3.3) | B | (3.5) |
| | bath liquid stability | A | | A | | A | | A | | A | |
| | | Example | | Example | | Example | | Example | | Example | |
| | | 6 | | 7 | | 8 | | 9 | | 10 | |
| type of | No. of emulsion (A) | E2 | | E2 | | E3 | | E3 | | E2 | |
| emulsion | No. of emulsion (B) | E6 | | E7 | | E4 | | E5 | | E4 | |
| | integrated emulsion | — | | — | | — | | — | | — | |
| blending | emulsion (A) [parts] | 2640 | | 2400 | | 2280 | | 3000 | | 2600 | |
| | emulsion (B) [parts] | 1360 | | 1600 | | 1720 | | 1000 | | 1400 | |
| | integrated emulsion [parts] | 0 | | 0 | | 0 | | 0 | | 0 | |
| | pigment dispersion paste [parts] | 0 | | 0 | | 0 | | 0 | | 400 | |
| | total [parts] | 4000 | | 4000 | | 4000 | | 4000 | | 4400 | |
| characteristic | solid content ratio of (A) | 66 | | 60 | | 57 | | 75 | | 65 | |
| | solid content ratio of (B) | 34 | | 40 | | 43 | | 25 | | 35 | |
| | N—H group concentration in (A) | 2.35 | | 2.35 | | 3.26 | | 3.26 | | 2.35 | |
| | epoxy group concentration in (B) | 4.40 | | 3.47 | | 4.28 | | 8.25 | | 4.28 | |
| | N—H group concentration in (A + B) | 1.55 | | 1.41 | | 1.86 | | 2.44 | | 1.52 | |
| | epoxy group concentration in (A + B) | 1.49 | | 1.39 | | 1.84 | | 2.06 | | 1.50 | |
| | reaction sites between the N—H | 1.49 | | 1.39 | | 1.84 | | 2.06 | | 1.50 | |
| | groups and the epoxy groups | | | | | | | | | | |
| evaluation | coating surface smoothness (Ra) | C | (0.43) | C | (0.41) | C | (0.52) | C | (0.58) | C | (0.44) |
| | curability (rubbing property) | B | | B | | A | | A | | A | |
| | rust prevention property (SST) | A | (2.2) | A | (2.4) | B | (3.2) | A | (2.7) | A | (2.0) |

| | | | | | |
|---|---|---|---|---|---|
| bath liquid stability | A | A | A | B | A |

TABLE 5

| | | Comparative | |
|---|---|---|---|
| | | Example 1 | |
| type of | No. of emulsion (A) | — | |
| emulsion | No. of emulsion (B) | — | |
| | integrated emulsion | E8 | |
| blending | emulsion (A) [parts] | 0 | |
| | emulsion (B) [parts] | 0 | |
| | integrated emulsion [parts] | 4000 | |
| | pigment dispersion paste [parts] | 0 | |
| | total [parts] | 4000 | |
| characteristic | solid content ratio of (A) | 70 | |
| | solid content ratio of (B) | 30 | |
| | N—H group concentration in (A) | — | |
| | epoxy group concentration in (B) | — | |
| | N—H group concentration in (A + B) | 1.05 | |
| | epoxy group concentration in (A + B) | 1.28 | |
| | reaction sites between the N—H groups | 1.05 | |
| | and the epoxy groups | | |
| evaluation | coating surface smoothness (Ra) | D | (0.71) |
| | curability (rubbing property) | A | |
| | rust prevention property (SST) | D | (5.5) |

| | |
|---|---|
| bath liquid stability | D |

### <Supplement to Contents in Tables 4 and 5>

The unit of the N—H group concentration, the epoxy group concentration, and the reaction sites between the N—H groups and the epoxy groups shown in the characteristic section is “meq/g-solid content” (milliequivalent per 1 g of solid content).
The reaction sites between the N—H groups and the epoxy groups shown in the characteristic section correspond to the smaller one of the N—H group concentration in (A+B) and the epoxy group concentration in (A+B).

TABLE 6

| | | Comparative | | Comparative | |
|---|---|---|---|---|---|
| | | Example 2 | | Example 3 | |
| type of | No. of emulsion (A) | E1 | | E1 | |
| emulsion | No. of emulsion (B) | E9 | | E9 | |
| | integrated emulsion | — | | — | |
| blending | emulsion (A) [parts] | 2400 | | 2720 | |
| | emulsion (B) [parts] | 1600 | | 1280 | |
| | integrated emulsion [parts] | — | | — | |
| | pigment dispersion paste | — | | — | |
| | [parts] | | | | |
| | total [parts] | 4000 | | 4000 | |
| characteristic | solid content ratio of (A) | 60 | | 68 | |
| | solid content ratio of (B) | 40 | | 32 | |
| | N—H group concentration | 1.50 | | 1.50 | |
| | in (A) | | | | |
| | C═C group concentration | 3.19 | | 3.19 | |
| | in (B) | | | | |
| | N—H group concentration | 0.90 | | 1.02 | |
| | in (A + B) | | | | |
| | C═C group concentration | 1.27 | | 1.02 | |
| | in (A + B) | | | | |
| | reaction sites between the | 0.90 | | 1.02 | |
| | N—H groups and the | | | | |
| | C═C groups | | | | |
| evaluation | coating surface smoothness | A | (0.28) | B | (0.38) |
| | (Ra) | | | | |
| | curability (rubbing property) | C | | C | |
| | rust prevention property | D | (6.2) | D | (7.5) |
| | (SST) | | | | |

| | | |
|---|---|---|
| bath liquid stability | A | A |

### <Supplement to Contents in Table 6>

The unit of the N—H group concentration, the C═C group concentration, and the reaction sites between the N—H groups and the C═C groups shown in the characteristic section is “meq/g-solid content” (milliequivalent per 1 g of solid content).
The reaction sites between the N—H groups and the C═C groups shown in the characteristic section correspond to the smaller one of the N—H group concentration in (A+B) and the C═C group concentration in (A+B).

As can be seen from Table 4, in all of Examples 1 to 10 satisfying the requirements of the present invention, two components of the amine-modified epoxy resin containing a highly reactive primary amino group or secondary amino group and the compound not containing a primary amino group and a secondary amino group and containing two or more epoxy groups in one molecule were separately blended into the emulsion (A) and the emulsion (B). Accordingly, in all of Examples 1 to 10, it was possible to obtain an excellent coating film that was acceptable in all of the coating surface smoothness, curability, and rust prevention property even without performing baking drying at a high temperature after formation of the coating film, and it was also excellent in bath liquid stability as a coating composition. On the other hand, in Comparative Example 1 in Table 5, two components of the amine-modified epoxy resin containing a highly reactive primary amino group or secondary amino group and the compound not containing a primary amino group and a secondary amino group and containing two or more epoxy groups in one molecule were mixed and present in the same emulsion. Accordingly, in Comparative Example 1, although the curability was excellent, the coating surface smoothness and the rust prevention property were unacceptable. The solution stability as a coating composition was also unacceptable. In Comparative Examples 2 and 3 in Table 6, a compound containing an α,β-unsaturated carbonyl group was used in place of a compound not containing a primary amino group and a secondary amino group and containing two or more epoxy groups in one molecule. In Comparative Examples 2 and 3, the rust prevention property was significantly inferior to that of Examples 1 to 10 and was unacceptable in terms of the rust prevention property.

### INDUSTRIAL APPLICABILITY

In the cationic electrodeposition coating composition of the present invention, the rate of the crosslinking reaction is controlled within a suitable range by appropriate selection of the type of the reactive group, whereby the curing time of the coating film can be extended to a suitable range. As a result, a coating film extremely excellent in rust prevention property can be obtained. In addition, a coating film having sufficiently high hardness can be obtained without requiring high-temperature baking drying. Accordingly, the combustion amount of the gas in the drying oven can be suppressed, and the CO₂ emission amount can be reduced. In addition, a blocking agent is not used. Accordingly, no byproduct (eliminated component) associated with the curing reaction is generated, and the load on the exhaust treatment facility can also be reduced. Therefore, the present invention is extremely useful.

1. A cationic electrodeposition coating composition containing at least two or more different emulsions in a mixed state, in which one of the emulsions is an emulsion (A) of an amine-modified epoxy resin containing a primary amino group or a secondary amino group, and another one of the emulsions is an emulsion (B) of an epoxy compound not containing a primary amino group and a secondary amino group and containing two or more epoxy groups in one molecule.

2. The cationic electrodeposition coating composition according to claim 1, wherein the emulsion (A) contains 1.40 to 3.35 milliequivalents of N—H groups of the primary amino group or the secondary amino group per 1 g of a solid content of the emulsion (A), the emulsion (B) contains 1.60 to 9.20 milliequivalents of epoxy groups per 1 g of a solid content of the emulsion (B), and the emulsion (A) and the emulsion (B) are mixed so that reaction sites between these functional groups are in a range of 0.95 to 2.25 milliequivalents per 1 g of a total solid content of the emulsion (A) and the emulsion (B).

3. The cationic electrodeposition coating composition according to claim 1, wherein the cationic electrodeposition coating composition further contains a basic catalyst and/or an organometallic compound catalyst as a curing catalyst.

4. The cationic electrodeposition coating composition according to claim 1, wherein the cationic electrodeposition coating composition further contains a pigment dispersion paste.

5. (canceled)

6. A method for producing a cationic electrodeposition coating composition, the method comprising the steps of: providing at least two or more different emulsions; and mixing the emulsions, wherein one of the emulsions is an emulsion (A) of an amine-modified epoxy resin containing a primary amino group or a secondary amino group, and another one of the emulsions is an emulsion (B) of an epoxy compound not containing a primary amino group and a secondary amino group and containing two or more epoxy groups in one molecule.

7. The method for producing a cationic electrodeposition coating composition according to claim 6, wherein the emulsion (A) contains 1.40 to 3.35 milliequivalents of N—H groups of the primary amino group or the secondary amino group per 1 g of a solid content of the emulsion (A), the emulsion (B) contains 1.60 to 9.20 milliequivalents of epoxy groups per 1 g of a solid content of the emulsion (B), and the emulsion (A) and the emulsion (B) are mixed so that reaction sites between these functional groups are in a range of 0.95 to 2.25 milliequivalents per 1 g of a total solid content of the emulsion (A) and the emulsion (B).

8. The method for producing a cationic electrodeposition coating composition according to claim 6, wherein the method further comprises the step of adding and mixing a basic catalyst and/or an organometallic compound catalyst as a curing catalyst, to the mixed emulsion.

9. The method for producing a cationic electrodeposition coating composition according to claim 6, wherein the method further comprises the steps of providing a pigment dispersion paste; and adding and mixing the pigment dispersion paste to the mixed emulsion.

10. The method according to claim 6, further comprising the steps of: immersing a metal object to be coated in the cationic electrodeposition coating composition; and then finishing the coating by low-temperature drying at 80° C. or lower.
